(19) United States
(12) Patent Application Publication
(10) Pub. No.: US 2014/0175786 A1
(43) Pub. Date: Jun. 26, 2014

(54) SECURITY STRUCTURE COMPRISING A TRANSPARENT VARNISH AND ASSOCIATED METHOD

(71) Applicant: ARJOWIGGINS SECURITY, Boulogne-Billancourt (FR)

(72) Inventors: Pierre Doublet, Saint Brice (FR); Michel Camus, Rives Sur Fure (FR)

(73) Assignee: ARJOWIGGINS SECURITY, Boulogne-Billancourt (FR)

(21) Appl. No.: 14/194,004

(22) Filed: Feb. 28, 2014

Related U.S. Application Data
(63) Continuation of application No. PCT/IB2012/054462, filed on Aug. 30, 2012.

(30) Foreign Application Priority Data
Sep. 2, 2011 (FR) 1157813

(51) Int. Cl. B42D 15/00

(52) U.S. Cl. CPC B42D 15/00
USPC 283/67; 283/91

(57) ABSTRACT

A security element for integration into a document. The security element has a transparent substrate. An array of lenses is disposed on the first side of the substrate. A field of elementary patterns observable through the array of lenses is disposed on the second side of the substrate. A transparent lacquer partially covers the array of lenses. The lacquer takes the form of at least one macroscopic pattern, which locally cancels out the effect of the lenses, thereby allowing an observation of the field of underlying elementary patterns tin halftone. The macroscopic patterns are not spatially coordinated with the field of elementary patterns.

### CROSS-REFERENCE TO RELATED APPLICATIONS

This nonprovisional application is a continuation of and claims priority to PCT Patent Application No. PCT/IB2012/054462, entitled “SECURITY STRUCTURE COMPRISING A TRANSPARENT VARNISH AND ASSOCIATED METHOD,” filed Aug. 30, 2012, which claims priority to French Patent Application No. FR 11/57,813 having the same title and a filing date of Sep. 2, 2011, both of which are herein incorporated by reference.

### BACKGROUND OF THE INVENTION

1. Field of the Invention

This invention relates to security structures. More specifically, it relates to security structures intended for insertion into security documents.

2. Brief Description of the Related Art

The expression “security document” is understood to mean a means of payment, such as a banknote, a check, or a restaurant voucher, an identity document, such as an identity card, a visa, a passport or a driving license, a lottery ticket, a transport ticket or even a ticket for entrance to sporting or cultural events. In order to prevent attempts to falsify or counterfeit a security document, it may be useful for a security structure to be easy to authenticate and/or identify.

It is known in the art to produce security structures comprising lenticular arrays that are associated with specific prints, in order to produce movement, depth and/or stereoscopic effects. The company SECURENCY sells such structures under the MOTION® trademark.

Such security structures exploit an optical structure one face of which is exposed to air, so that the difference between the refractive indices of air and of the material of the structure causes the desired refraction of light rays.

Optical effects obtained using lenticular arrays have especially been described in the article “The History of Integral Print Methods” which is an excerpt from “Lenz Array Print Techniques” by David E. Roberts and Trebor Smith, the article “The moiré magnifier” by M. C. Hutley et al. 1994 IOP Publishing Ltd., and the “Academy of the Sciences” publication from the session of 2 Mar. 1908.

Various examples of security structures comprising optical structures are especially known from publications FR 2 952 194, WO 2007/133613, US 2008/0182084, US 2005/0180020 and US 2008/0160226.

French patent FR 2 952 194 discloses a substrate bearing on an optical structure and a reference pattern. The optical structure creates an image of a comparative pattern. At least two comparative patterns may be located at different distances from the optical structure, in particular from the focal point of a lens of the optical structure, so that the images of these comparative patterns appear in different planes. An additional pattern may be produced by printing in order to form a backdrop on which the image is observed through the optical structure of the comparative patterns. As a variant, the optical structure focuses light into image points and the substrate comprises only the reference pattern and the optical structure. The optical structure may be formed by metallizing a lenticular array, the latter possibly comprising a Fresnel lens. Furthermore, the optical structure may be covered with a lacquer that cancels out the effects thereof.

WO 2007/133613 describes a substrate comprising a lenticular array and a pattern spatially coordinated with images produced by the lenticular array.

US 2008/0182084 teaches that the effect of lenses may be cancelled out by applying an adhesive to their surface. In one example, the structure comprises a substrate bearing, on one side, a lenticular array having lacquer-coated zones, and on the other, a diffractive structure and micro-images.

US 2005/0180020 discloses a multilayer structure comprising a lenticular array that may be overprinted.

US 2008/0160226 discloses a structure in which images formed by a lenticular array may be observed superposed on a pattern formed by demetallization.

Thus, lenticular arrays have been used in the prior art to allow them to be superposed on printed patterns so as to create movement effects, especially moiré magnification effects, on observation.

One of the drawbacks of moiré magnification effects is the need to be able to associate very small prints with the array of lenses, thereby requiring complex manufacturing processes.

Moreover, methods for incorporating security structures into security documents are known in the prior art, use of an adhesive making their incorporation easier.

However, applying an adhesive to the optical structures of a security structure may have the drawback of degrading the observed properties of the optical structures.

There is a need to attain security structures comprising an optical structure capable of producing novel optical effects able to contribute to the authentication and/or identification of an object, especially in a way that is simple.

There is also a need to attain such security structures capable of incorporating an adhesive in order to improve their incorporation into a security document while preserving the visual properties of their optical structures.

However, in view of the art considered as a whole at the time the present invention was made, it was not obvious to those of ordinary skill in the field of this invention how the shortcomings of the prior art could be overcome.

### BRIEF SUMMARY OF THE INVENTION

The long-standing but heretofore unfulfilled need for security structures capable of incorporating an adhesive in order to improve their incorporation into a security document while preserving the visual properties of their optical structures is now met by a new, useful, and nonobvious invention.

Thus, one object of the invention, in one of its aspects, is a security structure comprising a transparent substrate. An array of lenses is disposed on a first side of the substrate, while a field of elementary patterns is disposed on a second side of the substrate. The field of elementary patterns is observable through the array of lenses. A transparent lacquer partially covers the array of lenses. The lacquer takes the form of at least one macroscopic pattern locally cancelling out the effect of the lenses and allowing an observation of the field of underlying elementary patterns to be observed. The macroscopic patterns are not spatially coordinated with the field of elementary patterns.

Thus, the invention is capable of allowing a backdrop formed by the field of elementary patterns and a macroscopic pattern obtained from the transparent lacquer to be observed simultaneously. Advantageously, the transparent, preferably heat-sealing, lacquer may allow adhesion of the security structure to a security document to be made easier, but also allows one or more optical effects to be created. In particular, it may be possible to see the field of elementary patterns through the transparent lacquer, in order to create a background effect.

The substrate is preferably equipped with a field of individual elementary patterns. The macroscopic pattern may present a halftone appearance in the form of pixels corresponding to the underlying elementary patterns.

The halftone appearance may correspond to an image made up of an array of regularly spaced pixels, the shades of which are two in number, for example black and white.

The pixels according to the invention are formed by the elementary patterns of the field of elementary patterns. Thus, visually, these small elementary patterns may generate one or more shades, especially shades of gray. The reproduction of the image obtained may for example be a uniform gray color (monochromatic image) or even comprise several shades of gray, depending on the distribution of the elementary patterns and on optional variations in their size. An observer may compare the image obtained through the array of lenses, for example an enlarged image of the elementary patterns, and the image obtained through the lacquer.

The fact that the one or more macroscopic patterns are not spatially coordinated with the field of elementary patterns allows the one or more macroscopic patterns to be applied out of register with the field of elementary patterns. The fact that the one or more macroscopic patterns are not arranged with respect to the location of the field of elementary patterns simplifies manufacturing since the lacquer may be applied without taking the position of the field of elementary patterns into account. The relative position of the field of elementary patterns and the lacquer may thus be random. The lacquer may, for example, be deposited at regular intervals without it being necessary to precisely register the starting point of the application of the lacquer, in the longitudinal direction.

The array of lenses may create a virtual image of the field of elementary patterns, which appears behind the one or more macroscopic patterns.

The substrate may comprise a film made of a transparent thermoplastic, for example polyester or PET.

The array of lenses may completely cover the face of the substrate bearing the array of lenses, or, as a variant, cover it only partially.

The array of lenses may or may not extend lengthwise and/or widthwise from one edge of the substrate to the other.

The substrate may comprise one or more zones with no array of lenses, and one or more zones covered with the array of lenses.

The one or more macroscopic patterns produced from the transparent lacquer may be associated, for example additionally, with at least one second macroscopic pattern different from a lacquer, especially a holographic, printed, metallized, or demetallized second macroscopic pattern.

The one or more second macroscopic patterns may be added to the substrate, for example using a screen-printing, intaglio, laser, inkjet, micro-lithography, rotogravure or offset printing process.

The one or more second macroscopic patterns may be printed inter alia in opaque, fluorescent, phosphorescent, thermochromic, photochromic, translucent and/or transparent inks that are or are not colored, and that may be seen with the naked eye under ultraviolet (UV) and/or infrared (IR) light.

The array of lenses may be discontinuous. In particular, the array of lenses may consist of a set of separate optical subarrays that are either identical or not.

The array of lenses may be elongate along a longitudinal axis.

The array of lenses may have any geometric shape, for example of or not of polygonal outline, for example square, rectangle, diamond, triangle, trapezium, parallelogram, circular, elliptic, inter alia.

The array of lenses may have a thickness for example comprised between 2 and 30 μm, for example equal to 6 μm, and a diameter of the lenses may for example be comprised between 10 and 100 μm, and for example be equal to 20 μm.

The array of lenses may be produced by embossing, especially by thermal embossing or by embossing followed by ultraviolet crosslinking.

The one or more macroscopic patterns may, for example, correspond to a sign, logo, symbol, individual, object or alphanumeric character.

The security structure may form a security thread, a security film or a patch. Preferably, the security element is a security thread. The width of the security element may for example be larger than or equal to 4 mm, better 5 mm, even better 6 mm, and for example is comprised between 6 and 8 mm, better between 6 and 10 mm.

The optical structure may be formed on the substrate, from the same material or not, by addition or not.

The thickness of the substrate is for example comprised between 5 and 100 μm, and preferably between 20 and 30 μm. The substrate may have a constant thickness. The thickness of the substrate may optionally be chosen depending on the optical structure, for example depending on the focal length of this optical structure, so as to obtain the desired optical effect.

Another object of the invention, in another of its aspects, is a document, especially a security document, incorporating a security structure such as defined above.

The security structure may or may not extend from one edge of the document to the other.

The security structure may or may not be incorporated in one or more windows in the document.

A single or both of the faces of the security structure incorporated in the document may be partially or completely visible.

The document, or the security structure that it contains, may comprise one or more additional security elements such as defined below.

Among additional security elements, certain are detectable by eye, under daylight or artificial light, without any particular apparatus being required. These security elements for example comprise colored fibers or flakes, or partially or completely metallized or printed threads. These security elements are called first-level security elements.

Other types of additional security elements are detectable only using a relatively simple apparatus, such as a lamp emitting in the ultraviolet (UV) or infrared (IR). These security elements for example comprise fibers, flakes, strips, threads or particles. These security elements may or may not be visible to the naked eye, for example being luminescent under a Wood's lamp emitting at a wavelength of 365 nm. These security elements are called second-level security elements.

Other types of additional security elements require a more sophisticated detection apparatus to detect them. These security elements are, for example, capable of generating a specific signal when they are subjected, simultaneously or not, to one or more sources of exterior excitation. The automatic detection of the signal allows, if required, the document to be authenticated. These security elements for example comprise tracers taking the form of active materials, particles or fibers, capable of generating a specific signal when these tracers are subjected to an optronic, electric, magnetic or electromagnetic excitation. These security elements are called third-level security elements.

The one or more additional security elements present within the document, or the security structure that it contains, may have first-, second-, or third-level security features.

Another object of the invention, in another of its aspects, is a method for authenticating a document such as defined above, in which information relating to the authenticity of the document is generated at least by observing the latter.

### BRIEF DESCRIPTION OF THE DRAWINGS

For a fuller understanding of the invention, reference should be made to the following detailed description, taken in connection with the accompanying drawings, in which:

FIG. 1 is a cross-sectional view of a first exemplary embodiment of a security structure according to the present invention.

FIG. 2 is a top view of the first exemplary embodiment of the security structure according to the present invention.

FIG. 3 is a cross-sectional view of a second exemplary embodiment of a security structure according to the present invention.

FIG. 4 is a top view of the second exemplary embodiment of the security structure according to the present invention.

FIG. 5 is a top view of a document into which the security structure according to the present invention has been integrated.

### DETAILED DESCRIPTION OF THE PREFERRED EMBODIMENT

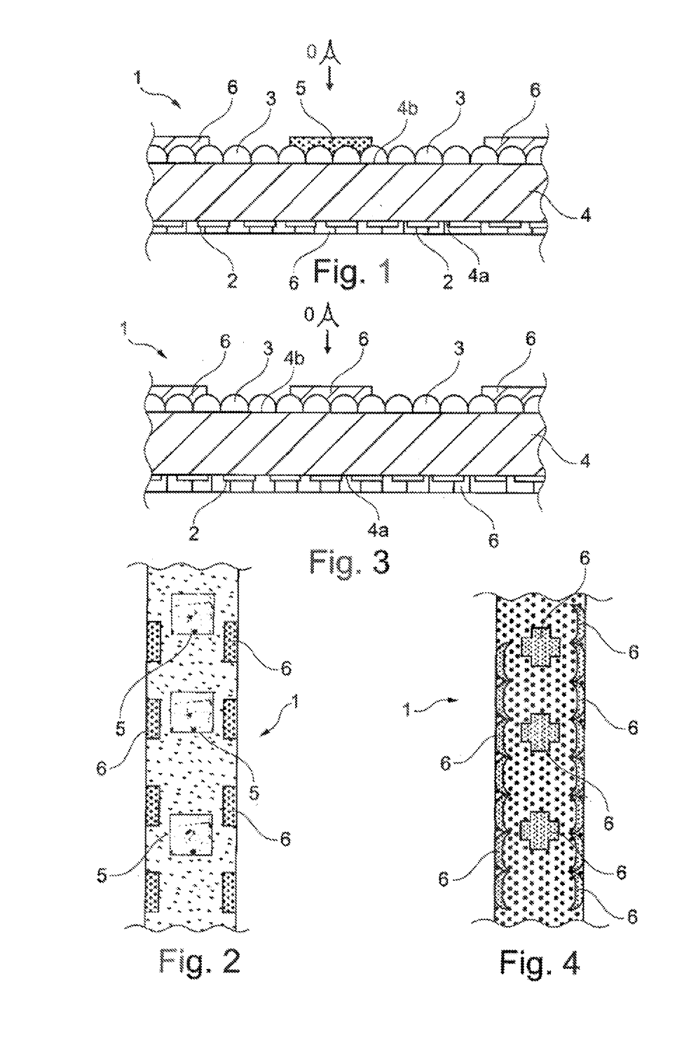

FIG. 1 shows an example security structure 1 according to the invention.

The security structure 1 may for example take the form of a security thread of width comprised between 4 and 8 mm, and for example equal to 6 mm.

The security structure 1 comprises a transparent substrate 4, for example made of polyester or polyethylene terephthalate (PET).

Face 4a of the substrate 4 comprises a field of elementary patterns 2 and the face 4b of the substrate 4 comprises an array of lenses 3, the field of elementary patterns 2 being observable through the array of lenses 3.

Furthermore, the array of lenses 3 is partially covered with a transparent lacquer 6, especially a transparent heat-sealing lacquer. This transparent lacquer 6 is placed over the array of lenses so as to form at least one macroscopic pattern locally cancelling out the optical effect of the lenses so as to allow an observation of the field of underlying elementary patterns 2 in halftone. The macroscopic pattern may therefore be formed from all of the elementary patterns 2 that it covers. It may thus form a halftone image.

In the example in FIG. 1, the transparent lacquer 6 is arranged in the form of two macroscopic patterns bordering the array of lenses 3. These macroscopic patterns are not spatially coordinated with the field of elementary patterns 2.

Moreover, the field of elementary patterns 2 is also covered with a transparent lacquer 6 on the side of the face 4a of the substrate 4.

A second macroscopic pattern 5 is formed on the array of lenses 3, this pattern for example being produced by printing, for example holographic printing, metallization or demetallization. The pattern 5 may, for example, correspond to a multicolor or multi-shade image, or to a hologram.

FIG. 2 shows the security structure 1 in FIG. 1 when observed from above by the observer O.

The field of elementary patterns 2 appears in the background when observed through the array of lenses 3, whereas the second macroscopic pattern 5 appears in the foreground. Furthermore, the macroscopic patterns formed by the transparent lacquer 6 bordering the security structure 1 appear in the foreground and allow the observation of the underlying elementary patterns 2 in halftone. These patterns 2 form a halftone image, the appearance of which is not modified by the lenses.

FIG. 3 shows another example security structure 1 according to the invention.

In this example, a macroscopic pattern formed by a transparent lacquer 6 is produced in place of the second macroscopic pattern 5 of the example embodiment in FIG. 1. The macroscopic patterns produced by the transparent lacquer 6 bordering the security structure 1 moreover have a different geometry from those in FIG. 1.

FIG. 4 shows a top view of the security structure 1 in FIG. 3 as observed by the observer O.

The field of elementary patterns 2 appears in the background when observed through the array of lenses 3, and notably in halftone when observed through the macroscopic patterns formed by the transparent lacquer 6, which lacquer 6 cancels out the optical effect of the lenses.

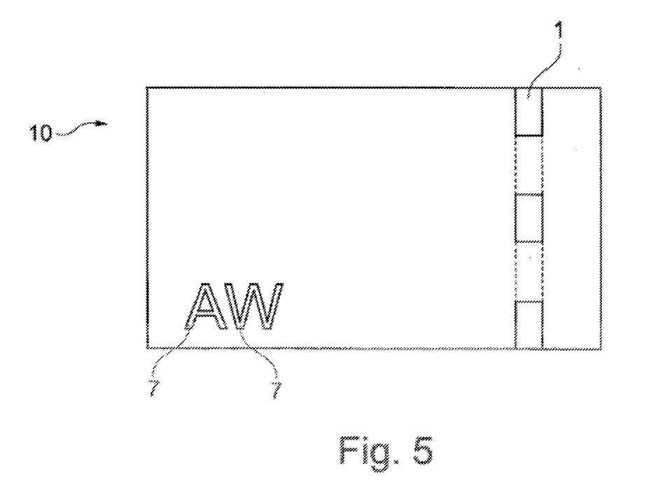

FIG. 5 shows an example security document 10 incorporating a security structure 1 according to the invention, for example such as shown in FIGS. 1 and 3.

The security structure 1 is for example inserted into one or more windows in the security document 10. As a variant, the security structure 1 may be completely or partially incorporated into the bulk of the security document 10.

In addition, the security document 10 may comprise other additional security elements 7, for example such as described above.

The expression “comprising a” must be understood as being synonymous with “comprising at least one”, unless the contrary is specified.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

What is claimed is:

1. A security structure comprising:
a transparent substrate;
on a first side of the substrate, an array of lenses;
on a second side of the substrate, a field of elementary patterns observable through the array of lenses,
a transparent lacquer partially covering the array of lenses, the lacquer taking the form of at least one macroscopic pattern locally cancelling out the effect of the lenses and allowing an observation of the field of underlying elementary patterns tin halftone, the one or more macroscopic patterns being not spatially coordinated with the field of elementary patterns.

2. The structure as claimed in claim 1, the array of lenses creating a virtual image of the field of elementary patterns, which appears behind the one or more macroscopic patterns.

3. The structure as claimed in claims 1, the array of lenses being produced by embossing, especially by thermal embossing or by embossing followed by ultraviolet crosslinking.

4. The structure as claimed in claim 1, the array of lenses (3) extending lengthwise and/or widthwise from one edge of the substrate to the other.

5. The structure as claimed in claim 1, the one or more macroscopic patterns produced from the transparent lacquer being associated with at least one second macroscopic pattern different from a lacquer, especially a holographic, printed, metallized, or demetallized second macroscopic pattern.

6. The structure as claimed in claim 1, the substrate comprising one or more zones with no array of lenses, and one or more zones covered with the array of lenses.

7. The structure as claimed in claim 1, forming a security thread or a patch.

8. A document incorporating a security structure as claimed in claim 1.

9. The document as claimed in claim 8, comprising one or more additional security elements.

10. A method for authenticating a document as claimed in claim 8, in which information relating to the authenticity of the document is generated at least by observing the latter
